(19) United States
(12) Patent Application Publication
(10) Pub. No.: US 2011/0100889 A1
(43) Pub. Date: May 5, 2011

(54) STERILZATION AND ANTI-BACTERIALZATION EQUIPMENT

(75) Inventors: Mari Saito, Tokyo (JP); Shiro Takeuchi, Tokyo (JP); Takuya Furuhashi, Tokyo (JP)

(73) Assignee: Mitsubishi Electric Corporation, Chiyoda-ku (JP)

(21) Appl. No.: 12/997,771

(22) PCT Filed: Apr. 7, 2009
(86) PCT No.: PCT/JP2009/057107

§ 371 Date: Dec. 13, 2010

(30) Foreign Application Priority Data
Jul. 31, 2008 (JP) 2008-197689

(51) Int. Cl. C02F 1/46

(52) U.S. Cl. 210/192

(57) ABSTRACT

The present invention relates to sterilization and anti-bacterialization equipment, in which an anode electrode and a cathode electrode having capability of creating active oxygen species are installed, and active oxygen species are created by making water to be treated intervene between both of electrodes and energizing the water between both electrodes, include the anode electrode made of a polymeric material or a material mainly made of the polymeric material.

### TECHNICAL FIELD

The present invention relates to sterilization and anti-bacterialization equipment which makes possible continuous creation of active oxygen species, which are useful to sterilization and anti-bacterialization.

### BACKGROUND ART

There are conventional methods for creating active oxygen species, in which voltage is applied to electrodes immersed in water to be treated and active oxygen species are created by making use of electrolysis of water (see, for example, Patent Document 1). In these cases, the electrodes are composed of a cathode which is capable of creating active oxygen species and an anode which is composed of low surface-resistant metal or carbon material. With the cathode electrode, active oxygen species such as superoxide (O₂—), hydroxyl-radical (.OH) and hydrogen peroxide (H₂O₂) are created. These active oxygen species make the microbes in the water to be treated inactive and sterilization and anti-bacterialization of the water is performed.

### PRIOR ART DOCUMENTS

### Patent Documents

[Patent Document 1] Japanese Unexamined Patent Application Publication No. 2003-000957

### DISCLOSURE OF INVENTION

### Problems to be Solved by the Invention

In traditional methods, a lot of hydrogen and chlorine are produced as by-products. Since active oxygen species created with a cathode electrode were partly disappeared at an anode electrode, the amount of active oxygen species in appearance was less than the actual amount of active oxygen species created with the cathode electrode. For example, when carbon material is used for the anode electrode, the active oxygen species turn to carbon dioxide (CO₂) in oxidizing reaction. Also, when relatively chemically stable metal, such as titanium is used for the anode electrode, the active oxygen species turn to metal oxide in oxidizing reaction. As a result of these phenomena, a problem such that the active oxygen species necessary for the performance capable of sterilization and anti-bacterialization could not stably created over a long period of time.

The objective of the present invention is to provide equipment capable of creating necessary amount of active oxygen species for sterilization and anti-bacterialization in the water to be treated, for long time. This can be attained by making the amount of active oxygen species consumed at the anode electrode restrained and the amount of active oxygen species in appearance close to the amount actually created with the cathode electrode, so that the creating efficiency is improved.

### Means for Solving Problems

The sterilization and anti-bacterialization equipment according to the present invention is provided with an anode electrode and a cathode electrode capable of creating active oxygen species. In the sterilization and anti-bacterialization equipment in which active oxygen species are created by energizing the water intervening between both electrodes, the anode electrode is made of an electrically conductive material which is mainly made of a polymeric material.

### Advantages

Oxidation reaction usually occurs with the anode electrode; for example, chlorine and hydroxide in tap water supply electrons. On the other hand, the active oxygen species created with the cathode electrode are spread in the water to be treated and it is expected that they will make microbes such as bacteria inactive. However, since the movement of the active oxygen species spread in a solvent can not be controlled, part of them are practically consumed in the oxidation reactions of the anode electrode.

Since sterilization and anti-bacterialization equipment according to the present invention is provided with the anode electrode made of a polymeric material as a main material (a base material), which is hardly oxidized by the active oxygen species, it becomes possible that consumptive reaction of active oxygen species created with the cathode electrode is restrained, the amount of created active oxygen species in appearance is increased, and therefore the efficiency of the actual creation of active oxygen species can be improved. Consequently, because a large amount of active oxygen species can stably exist in the water to be treated, the capability of sterilization and anti-bacterialization of the water improves.

### BRIEF DESCRIPTION OF DRAWINGS

FIG. 1 is a constitution diagram in accordance with the first embodiment of the present invention.

FIG. 2 is a graph showing the relationship among the materials of an anode electrode, time from the start of the reaction and the amount of created hydrogen peroxide.

FIG. 3 is a graph showing the surface resistance of an anode electrode made of ABS resin and the amount of hydrogen peroxide created after three hours from the start of the reaction.

FIG. 4 is a perspective view showing a part of a sterilization and anti-bacterialization equipment in accordance with the second embodiment, where sterilization and anti-bacterialization are performed.

FIG. 5 is a perspective view showing a part of a sterilization and anti-bacterialization equipment in accordance with the third embodiment, where sterilization and anti-bacterialization are performed.

FIG. 6 is an explanatory diagram of a first example (a) and an explanatory diagram of a second example (b), each showing a part of sterilization and anti-bacterialization equipment in accordance with the third embodiment where sterilization and anti-bacterialization are performed.

FIG. 7 is a constitution side view (a) and a constitution front view (b), each showing the part of sterilization and anti-bacterialization equipment in accordance with the fourth embodiment, where sterilization and anti-bacterialization are performed.

### MODES FOR CARRYING OUT THE INVENTION

Embodiments of the sterilization and anti-bacterialization equipment according to the present invention will be described hereunder with reference to the accompanying drawings.

### Embodiment 1

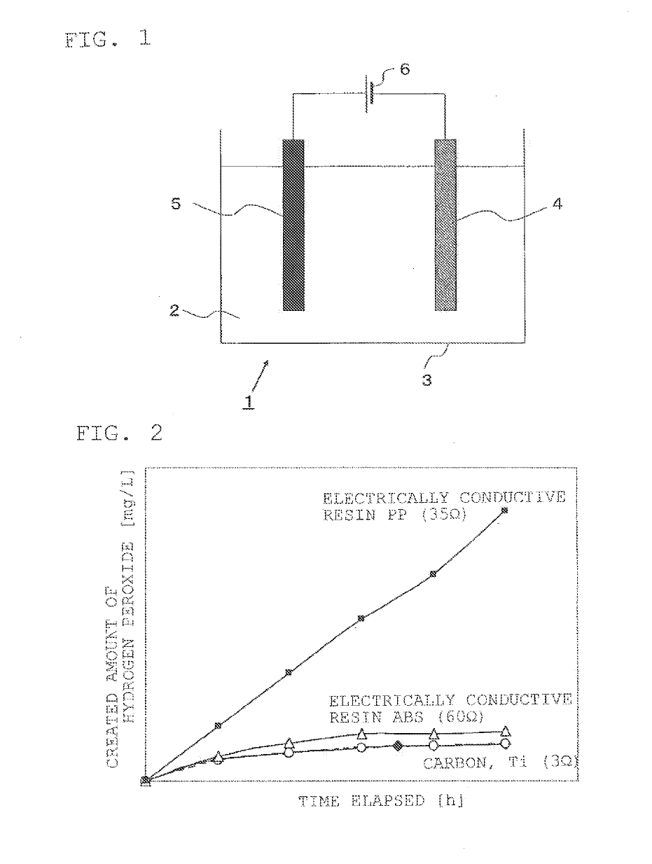

FIG. 1 is a schematic constitution diagram in accordance with a first embodiment of the present invention. The sterilization and anti-bacterialization equipment 1 includes a reaction chamber 3 for storing water to be treated 2 and creating active oxygen species, a pair of electrodes consisting of a cathode electrode 4 having capability of creating active oxygen species and an anode electrode 5, both of which are disposed such that at least some part of them are immersed in the water 2, and a power source 6 for energizing said electrodes 4 and 5.

The cathode electrode 4 is made of carbon, metal or other electrically conductive material. It is favorable that a material having the capability of catalysis, which makes active oxygen species such as superoxide (O₂—), hydroxyl radial (.OH) and hydrogen peroxide (H₂O₂), which makes active oxygen species easily created, or an electrically conductive polymeric material such as polyaniline, be brought into contact with the surface of the cathode electrode 4.

The anode electrode 5 is made of a polymeric material or a material mainly made of the polymeric material. It is not important whether the polymeric material used is electrically conductive or not. However, the electrode 5 needs to be electrically conductive. Therefore in case when a polymeric material without electrical conductivity is used for the electrode 5, it shall be manufactured by mixture with the electrically conductive material such as carbon-filler in order to add the electrical conductivity to the electrode 5. (The resin provided with the electrical conductivity is designated as “electrically conductive resin” hereafter.) Consequently, since the anode electrode can be made mainly of polymeric materials such as polypropylene (PP), PET and ABS resin, which have no electrical conductivity but property of acid-resistance or alkali-resistance, this structure can prevent the anode 5 from being corroded by the water to be treated or the active oxygen species. Also, electrical conductivity, acid-resistance and alkali-resistance of the anode electrode 5 can be improved by making the anode electrode 5 manufactured by mixing electrically conductive polymer (such as polyaniline).

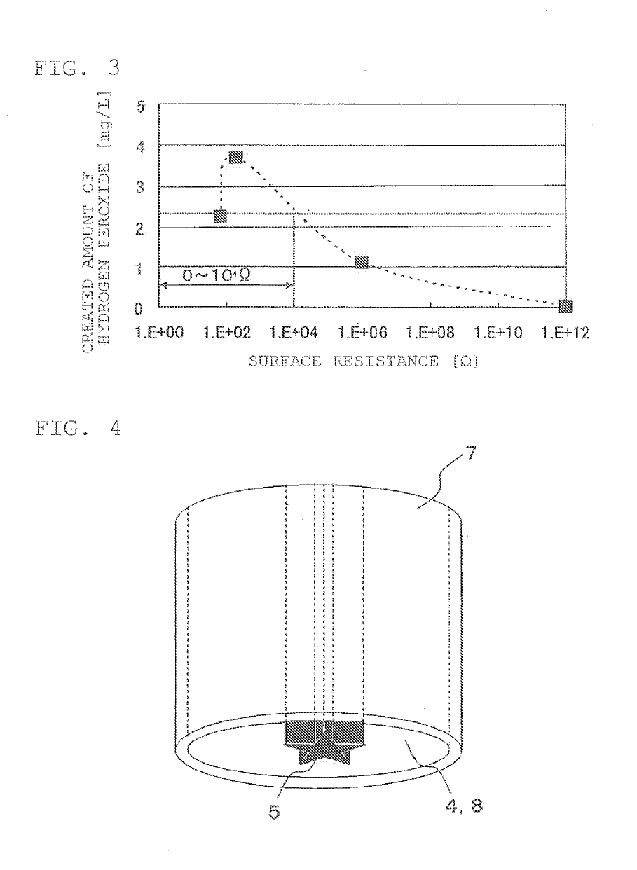

By using the sterilization•anti-bacteria equipment as shown in FIG. 1, the amount of created hydrogen peroxide (H₂O₂), which is one kind of active oxygen species, was measured. Here, the capability of creating active oxygen species was provided to the cathode electrode 4 by means that a material having the property of catalytic action, such as polyaniline, by which active oxygen species were produced by reduction of dissolved oxygen in the water to be treated, was brought into contact with the surface of the cathode electrode 4. Also, for the anode electrode 5, the same objective measurements by using the following four kinds of materials, carbon, metal (Ti) and the electrically conductive resins, (PP, ABS) were conducted. According to the measurements, as shown in FIG. 2, the concentration of the hydrogen peroxide in the water to be treated became an equilibrium state after approximately five hours from the start of reaction. The amounts of hydrogen peroxide after three hours from the start of reaction were 1.7 mg/L with the carbon (surface resistance 3Ω), 1.7 mg/L with the metal (Ti, surface resistance 1Ω), 9.3 mg/L with the electrically conductive resin (PP, surface resistance 35Ω) and 4.0 mg/L with the electrically conductive resin (ABS, 60Ω). As a result of these measurements, it was understood that the amount of created hydrogen peroxide in appearance varies depending on the material being used for the anode electrode 5, although the surface resistance of the anode affected this result.

Also, the created amount of hydrogen peroxide was measured with the anode electrode 5 of which the main constituent material was ABS resin and the surface resistance was 60-10¹¹Ω.

According to the measurements, as shown in FIG. 3, the created amounts of hydrogen peroxide after three hours from the start of reaction were 3.4 mg/L with the surface resistance 60Ω, 3.7 mg/L with the surface resistance 200Ω and 1.1 mg/L with the surface resistance 10⁸Ω. In these measurements, hydrogen peroxide was not created when ABS resin with surface resistance of 10¹¹Ω was used, because the water between the two electrodes could not be energized at this time.

According to these measurements, it was turned out that when the surface resistance of the anode electrode 5 was between 1Ω and 200Ω, the amount of hydrogen peroxide consumed on the surface of anode electrode 5 was restrained, and, as a result of this, the amount of usable hydrogen peroxide was increased. Also, when the surface resistance of the electrode 5 was between 200Ω and 10⁶Ω, decreased of the amount of created hydrogen peroxide caused by decreasing the amount of electrons per unit time received by the cathode electrode 4 was more than decrease of the amount of hydrogen peroxide consumed on the surface of the anode electrode 5, so that the amount of usable hydrogen peroxide was consequently decreased.

By the reasons stated above, in case that the main composed material of the anode electrode 5 is a polymeric material, in comparison with a case that the main composed material of anode electrode 5 is not a polymeric material, consumptive reaction of the hydrogen peroxide on the surface of the anode electrode 5 can be restrained, and, therefore, the amount of hydrogen peroxide in the water to be treated is increased. In addition, it is possible that the corrosion of the anode electrode 5 caused by the hydrogen peroxide created with the cathode electrode 4 can be prevented, when the polymeric material, which does not easily affect the consumption reaction of the hydrogen peroxide around the anode electrode 5, is used for the electrode 5 or a main material of the electrode 5. Therefore, since the consumption reaction of hydrogen peroxide around the anode electrode 5 can be restrained by means of using the above mentioned constitution in the sterilization and anti-bacterialization equipment, the efficient creation of hydrogen peroxide can be carried out, so that the capability of sterilization and anti-bacterialization of the sterilization and anti-bacterialization equipment can be improved.

Consequently, as shown in FIG. 3, the decreased amount of hydrogen peroxide consumed on the surface of the anode electrode 5 is made more than the decreased amount of hydrogen peroxide created with the cathode electrode 4, by making the surface resistance of the anode electrode 5 set to be 0-10⁴Ω. As a result, the amount of usable hydrogen peroxide can be increased.

The water to be treated 2 mentioned in the first embodiment includes not only tap water, groundwater, water for the industrial use and drinking water but also water in a pool or a bathhouse, seawater and water to be supplied to various kinds of industrial facilities. Also, the microbes to be considered for the sterilization•anti-bacterialization action in the first embodiment are bacteria, hyphomycetes, colibacillus, yeast, unicellular organism, protozoa, virus and so forth.

Furthermore, in the first embodiment, both electrodes 4 and 5 are not necessarily arranged oppositely to each other; moreover, more than two electrodes 4 and 5 may be disposed within the reaction chamber 3.

Also, in the first embodiment, it is not necessary that the material having a property of catalysis such as polyaniline is attached to the cathode electrode 4.

### Embodiment 2

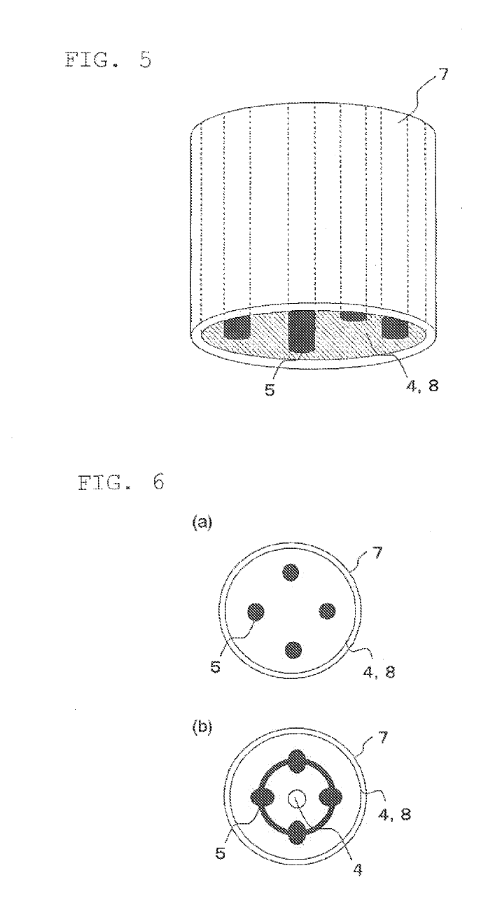

FIG. 4 is a perspective view of a part of a sterilization and anti-bacterialization equipment in accordance with a second embodiment of the present invention, where water to be treated is sterilized and anti-bacterialized. Here, an inner wall 8 of a tube 7, in which water to be treated flows, is let to be a cathode electrode 4, having the capability of creation of the active oxygen species. On the other hand, an anode electrode 5 having a polygonal shaped outer circumference is disposed in the middle of the tube 7. In this equipment, the tube 7 plays the same roll as the reaction chamber 3 in FIG. 1.

Since the sterilization and anti-bacterialization equipment in accordance with the second embodiment has a structure, in which the polygonal shaped anode electrode 5 is disposed in the middle of the tube 7, products created around the both electrodes can flow down without coming in contact with the opposed electrode. Also, the shape of the anode electrode 5 is polygonal, so that the area in contact with the water to be treated is increased.

In this constitution, because the water flowing down in the tube 7 is not easily agitated, active oxygen species created with the cathode electrode 4 are hardly brought into contact with the anode electrode 5 and hardly consumed at the anode electrode 5. With this constitution, the amount of created active oxygen species in appearance can be made close to the actual amount of active oxygen species created, without some special measures to be taken such as setting ion-exchange membrane between the cathode electrode 4 and the anode electrode 5. Moreover, sufficient electron-receiving area can be secured even in the reduced space.

In addition, since some active oxygen species are created around the inner wall 8 of the tube 7, the chances of contact with the microbes in the water to be treated increase, and, therefore, the effect for the capability of sterilization and anti-bacterialization is improved. Also, since it is expected that sterilization and anti-bacterialization can be efficiently carried out even in the reduced space, sterilization and anti-bacterialization can be carried out in places such as the inside of a drain pipe of an air conditioner.

By making the sterilization and anti-bacterialization equipment constructed using the inner wall of the tube 7 as the one in the second embodiment, the efficient sterilization and anti-bacterialization can be can be carried out.

### Embodiment 3

FIG. 5 is a perspective view of a part of a sterilization and anti-bacterialization equipment, in accordance with the third embodiment of the present invention, where water to be treated is sterilized and anti-bacterialized. This is a variation of the second embodiment, and the different point from the second embodiment is that a plurality of the anode electrodes 5 is disposed along the inner wall 8 of the tube 7

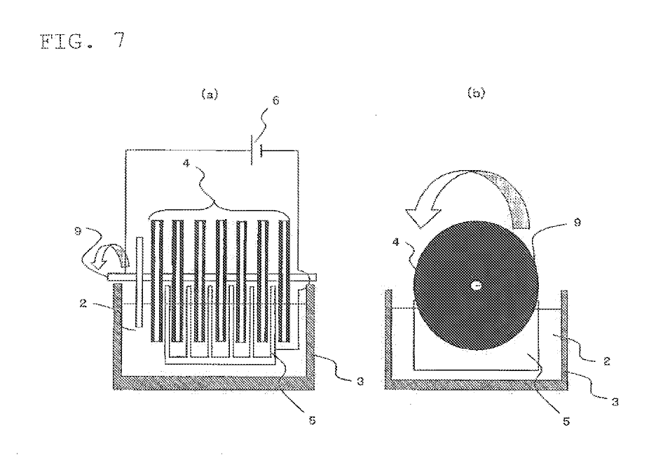

FIG. 6 is explanatory diagrams of a first example (a) and a second example (b), each showing a part of the sterilization and anti-bacterialization equipment, in accordance with the third embodiment, where sterilization•anti-bacterialization of water to be treated is performed. The anode electrodes 5 can independently be installed inside the inner wall 8 of the tube 7 as shown in FIG. 6 (a) or can be connected to each other as shown in FIG. 6 (b). Also, one another cathode electrode 4 can be additionally installed in the middle of the tube 7 in addition to the inner wall 8.

Furthermore, in the second and the third embodiments, it is favorable that the outer circumference of the tube 7 is wrapped with the insulated material such as rubber so as to present leakage of current.

In the sterilization and anti-bacterialization equipment in accordance with the third embodiment, since the anode electrodes 5 are located along the inner wall 8 of the tube 7 (the shape of the outer circumference of one anode electrode can be a circular cylinder or a polygon), products created around both of the anode electrodes 5 and the cathode electrode 4 can flow down without coming in contact with the other opposed electrodes. In addition, the contact area with the water to be treated 2 can be increased by means of a plurality of anode electrodes 5 installed. Consequently, the sterilization and anti-bacterialization effect of the sterilization and anti-bacterialization equipment in accordance with the third embodiment can be more than or equal to that of the equipment in accordance with the second embodiment.

### Embodiment 4

FIG. 7 is a constitution side view (a) and a constitution front view (b), each showing a part of the sterilization and anti-bacterialization equipment in accordance with the fourth embodiment of the present invention, where sterilization and anti-bacterialization of water to be treated is performed. Here, the water to be treated 2 is reserved in a reaction chamber 3, and a plurality of plate-shaped anode electrodes 5 are maintained in stationary conditions and disposed in parallel at equal intervals within the reaction chamber 3. A plurality of disk-shaped cathode electrodes 4, which are able to be rotated, are disposed between plate-shaped anode electrodes 5.

The central part of each disk-shaped cathode electrode 4 is attached to the electrically conductive rotational shaft 9, and these electrodes are rotatable with the rotational shaft 9. Also, this equipment is designed so that the upper part of the electrode 4 is located in air, and the lower part in the water.

In the sterilization and anti-bacterialization equipment in accordance with the fourth embodiment, a part projected out of the surface of the water 2 and a part immersed in the water 2 exist by making the cathode electrode 4 rotatable. Since the cathode electrodes 4 are rotated around the rotational shaft 9, they can be positioned so that a part of them alternately comes into and goes out of the water 2. Furthermore, it is favorable that the twist of wiring caused by the disk rotation is prevented by making the rotational shaft 9 electrically conductive.

In this equipment constitution, water membrane is always formed on the surface of the part projected out of the surface of the water 2, by adjusting the velocity of rotation, in order for the cathode electrode 4 not to be dried. Also, since the cathode electrodes 4, which have the property of creating active oxygen species, are rotatable, they periodically come in contact with a large amount of oxygen, and as a result, the efficient creation of active oxygen species is made possible.

Also, although in FIG. 7, the upper part of the cathode electrode 4 (approximately two third of the entire electrode) is positioned in the air and the lower part (approximately one third) in the water 2, the constitution of the equipment is not necessarily limited to this example. For instance, by making half of the entire cathode electrode 4 immersed in the water 2, the cathode electrode 4 can be immersed the water 2, and brought in contact with the air as a whole, and, as a result, the efficient creation of active oxygen species are made possible.

Also, although the above mentioned first to the fourth embodiments were explained in the cases that the anode electrodes 5 were made of electrically conductive resins, the cathode electrodes 4 can also be made of electrically conductive resins.

Furthermore, the material used for the cathode or the anode, which was explained in the first embodiment, can also be utilized in the fourth embodiment.

### REFERENCE NUMERALS

1 sterilization and anti-bacterialization equipment, 2 water to be treated, 3 reaction chamber, 4 cathode electrode, 5 anode electrode, 6 power source, 7 tube, 8 inner wall of the tube, 9 rotational shaft

1. Sterilization and anti-bacterialization equipment for creating active oxygen species, comprising
an anode electrode and a cathode electrode having the capability of creating active oxygen species,
water to be treated intervening between said both electrodes, the water between said both electrodes being electrically energized to create active oxygen species, wherein
said anode electrode is made of a polymeric material or mainly made of the polymeric material.

2. The sterilization and anti-bacterialization equipment according to claim 1, wherein:
said anode electrode is made of a polymeric material mixed with an electrically conductive material.

3. The sterilization and anti-bacterialization equipment according to claim 1, wherein:
said anode electrode is made of a polymeric material having a property of acid-resistance and/or alkali-resistance.

4. The sterilization and anti-bacterialization equipment according to claim 1, wherein:
said cathode electrode is disposed to be rotated freely around a rotational shaft so that a part of it comes in and goes out of the water to be treated and air alternately.

5. The sterilization and anti-bacterialization equipment according to claim 4, wherein:
said rotational shaft is made electrically conductive.

6. The sterilization and anti-bacterialization equipment according to claim 1, wherein:
the range of surface resistance of said anode electrode lies between 0Ω and 10⁴Ω.

7. The sterilization and anti-bacterialization equipment according to claim 2, wherein:
said anode electrode is made of a polymeric material having a property of acid-resistance and/or alkali-resistance.

8. The sterilization and anti-bacterialization equipment according to claim 2, wherein:
said cathode electrode is disposed to be rotated freely around a rotational shaft so that a part of it comes in and goes out of the water to be treated and air alternately.

9. The sterilization and anti-bacterialization equipment according to claim 3, wherein:
said cathode electrode is disposed to be rotated freely around a rotational shaft so that a part of it comes in and goes out of the water to be treated and air alternately.

10. The sterilization and anti-bacterialization equipment according to claim 2, wherein:
the range of surface resistance of said anode electrode lies between 0Ω and 10⁴Ω.

11. The sterilization and anti-bacterialization equipment according to claim 3, wherein:
the range of surface resistance of said anode electrode lies between 0Ω and 10⁴Ω.

12. The sterilization and anti-bacterialization equipment according to claim 4, wherein:
the range of surface resistance of said anode electrode lies between 0Ω and 10⁴Ω.

13. The sterilization and anti-bacterialization equipment according to claim 5, wherein:
the range of surface resistance of said anode electrode lies between 0Ω and 10⁴Ω.
